(19) United States
(12) Patent Application Publication
(10) Pub. No.: US 2019/0221980 A1
(43) Pub. Date: Jul. 18, 2019

(54) ELBOW CONNECTOR

(71) Applicant: INTERLEMO HOLDING S.A., Ecublens (CH)

(72) Inventors: Christian Schweiger, Poing (DE); Josef Stanner, Buch am Buchrain (DE)

(73) Assignee: INTERLEMO HOLDING S.A., Ecublens (CH)

(21) Appl. No.: 16/328,761

(22) PCT Filed: Aug. 28, 2017
(86) PCT No.: PCT/EP2017/071561

§ 371 Date: Feb. 27, 2019

(30) Foreign Application Priority Data
Aug. 30, 2016 (EP) 16186458.2

(51) Int. Cl. H01R 35/04

(52) U.S. Cl. CPC H01R 35/04

(57) ABSTRACT

Elbow connector for pluggable interconnection of an electrical cable to a mating connector, the elbow connector including a casing comprising a plug portion and a separable elbow portion, a connection terminal assembly mounted in the casing comprising a plurality of electrical terminals supported by a terminal housing mounted fixedly in the plug portion, and a keying arrangement complementary to a keying arrangement of said mating connector for angular orientation of the connection terminal assembly about a plugging axis relative to the mating connector, the elbow portion comprising a cable receiving cavity extending from a cable receiving end of the elbow portion to the plug portion through a bend.

The present invention relates to a multi-terminal electrical elbow connector for pluggable connection to a complementary connector, in particular a mating connector mounted on a panel or structure. The elbow connector interconnects a multi-conductor electrical cable to the complementary connector.

Elbow connectors are well-known and allow a cable to exit a connection panel or other structure at a right angle to the plugging direction of the connector. Cables exiting the connector coupling are oriented initially in a direction that is essentially parallel to a panel or other surface on which the complementary or mating connector is mounted. Electrical connectors that are provided with a plurality of electrical terminals often need to be plugged in a certain angular orientation with respect to the mating connector. The orientation and guiding of the connector and mating connector may be provided by a polarizing or keying arrangement ensuring that the complementary connectors can only be plugged together in a certain angular orientation. In certain applications, the keying arrangement may further comprise not only a polarizing element that ensures that the connectors are properly oriented, but also keying elements that ensure that only certain connectors may be coupled together, i.e. those provided with the same complementary keying element arrangements.

When a plurality of mating connectors are provided on a panel or other structure, cables may interfere with other connectors and reduce the ability to mount connectors in a dense arrangement together. Moreover, in certain situations, since the elbow connector needs to be oriented with respect to the mating panel connector in a certain orientation, the direction of exit of the cable may not be optimal. Such problems may be overcome by providing an elbow connector with a cable exit portion that is rotatable with respect to the plugging portion of the connector, for example, as disclosed in EP0818854. In this prior art document, the cable outlet section of the connector can rotate up to almost 360° around the plugging axis. This however has a number of disadvantages in certain situations. One drawback is that cycles of rotation of the cable outlet portion with respect to the plugging portion can lead to fatigue and rupture of the electrical connection between conducting wires and electrical terminals mounted in the connector. In addition, in many situations, it is desirable to exit the cable from a structure in a predefined direction and to prevent rotation of the cable once plugged.

It is an object of the invention to provide an elbow connector that overcomes the aforementioned drawbacks.

It is advantageous to provide an elbow connector that is cost effective to assemble and install, and easy to use.

It is advantageous to provide an elbow connector that is compact, robust and reliable.

Objects of the invention have been achieved by providing an elbow connector according to claim 1.

Disclosed herein is an elbow connector for pluggable interconnection of an electrical cable to a mating connector, the elbow connector including a casing comprising a plug portion and a separable elbow portion, a connection terminal assembly mounted in the casing comprising a plurality of electrical terminals supported by a terminal housing mounted fixedly in the plug portion, and a keying arrangement complementary to a keying arrangement of said mating connector for angular orientation of the connection terminal assembly about a plugging axis (A) relative to the mating connector. The elbow portion comprises a cable receiving cavity extending from a cable receiving end of the elbow portion to the plug portion via a bend, for instance a right angle bend. The plug portion and elbow portion each comprise inter-engaging orientation elements configured to allow the elbow portion to be positioned at different discrete angular orientations about the plugging axis (A) relative to the plug portion, the casing further comprising a fastener locking the plug portion to the elbow portion such that the chosen angular orientation of the elbow portion relative to the plug portion is blocked.

The plug portion may comprise an essentially cylindrical or tubular shape.

In an embodiment, the orientation elements comprise at least one protuberance or recess on one of the plug portion and elbow portion and a plurality of complementary recesses or protuberances on the other of the plug portion and elbow portion.

In an embodiment, the orientation elements may be arranged such that the angular orientation of the elbow portion relative to the plug portion consists of discrete angular positions separated by at most 120° and at least 5°, preferably at most 90° and at least 15°.

Preferably, the orientation elements are arranged such that the angular orientation of the elbow portion relative to the plug portion consists of discrete angular positions separated by at most 60° and at least 15°. Preferred discrete angular increments for embodiments of the inventions are for instance 45° or 30° or 22.5° since these provide a reasonable number of angular positions (8, 12 and 16 respectively) over the full 360° to adapt to obstacles proximate the connector, yet avoid having too many angular positions that are not easy to discern.

In an embodiment, the plug portion comprises a latching mechanism configured for latching the plug portion to the mating connector, the latching mechanism comprising at least one spring arm with at least one latching protuberance, the connector further comprising an unlocking member movable from a locking position to an unlocking position configured to actuate the spring arm to release the latching protuberance to enable unplugging of the elbow connector from the mating connector. The unlocking member may be in the form of a tubular sleeve mounted around the plug portion.

In an embodiment, the keying arrangement comprises a protuberance or groove in the plug portion, or in an unlocking member mounted around plug portion, engaging with a complementary groove or protuberance on the mating connector.

The elbow connector may further comprise a cable clamping mechanism comprising a collet inserted in the cable receiving cavity of the elbow portion, and a collet nut engaging clamp arms of the collet to tighten the clamp arms around an outer sheath of the cable to secure the cable to the connector.

In an embodiment, the collet advantageously comprises an anti-rotation window and the elbow portion comprises an anti-rotation lug deformed into anti-rotation window when the collet is assembled in the elbow portion, whereby prior to assembly the anti-rotation lug is in an undeformed state allowing insertion of the collet in the cable receiving cavity.

In an embodiment, the anti-rotation lug is in a form of a tab integrally formed and partially cut out of a side wall of the elbow portion.

In an embodiment, the orientation elements comprise teeth and complementary recesses extending in the direction of the plugging axis (A) from respective interfaces of the plug portion and elbow portion.

In an embodiment, the fastener may be in the form of a nut comprising a thread engageable with a complementary thread provided on the elbow portion and a shoulder engaging a complementary shoulder on the plug portion of the casing.

Further objects and advantageous features of the invention will be apparent from the claims, from the detailed description, and annexed drawings, in which:

FIG. 1 is a perspective view of an elbow connector according to an embodiment of the invention, in line to be plugged to a mating connector;

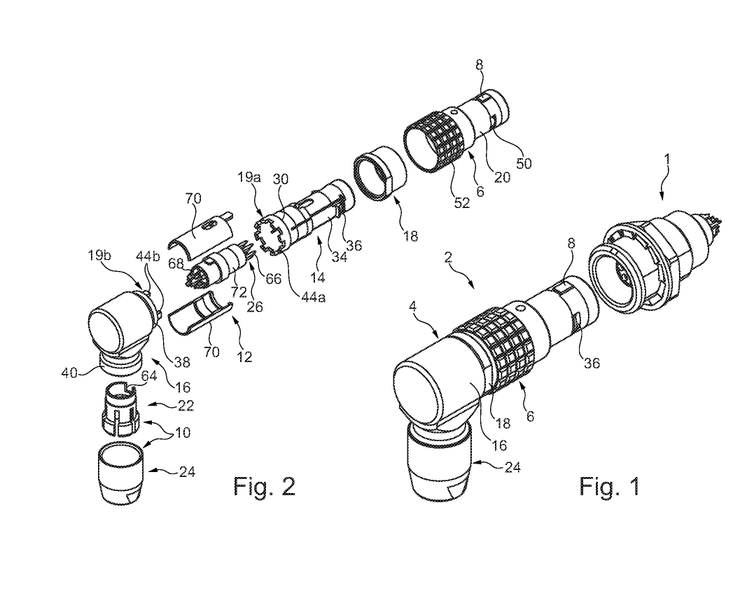

FIG. 2 is an exploded perspective view of the elbow connector according to an embodiment of the invention;

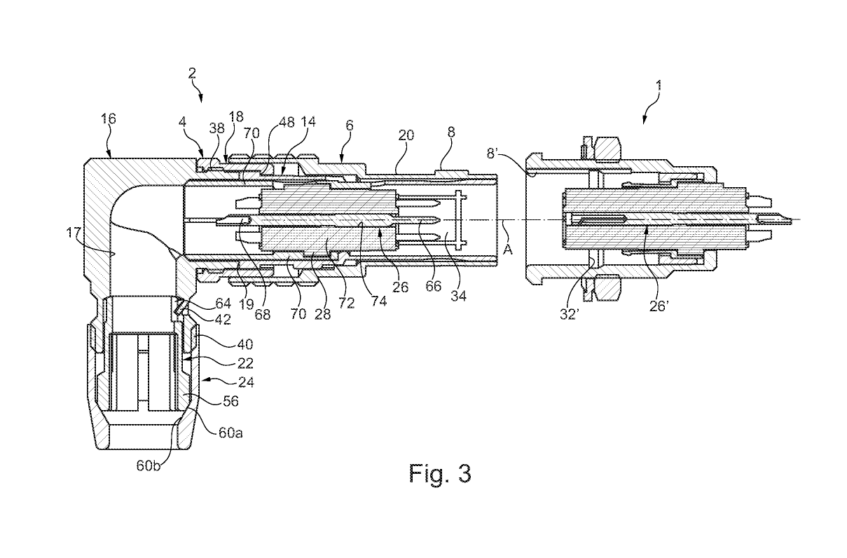

FIG. 3 is a cross-sectional view of an elbow connector according to an embodiment of the invention, in line to be plugged to a mating connector;

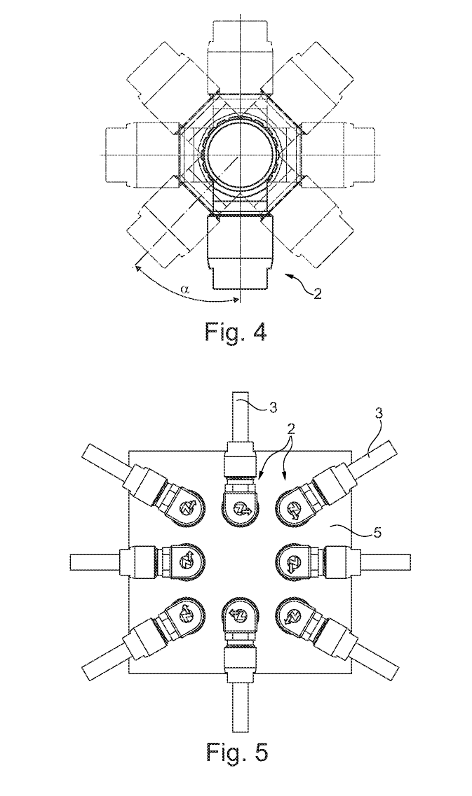

FIG. 4 is a view in a plugging direction illustrating an elbow connector according to an embodiment of the invention plugged to a mating connector, showing different orientation angles in dotted lines;

FIG. 5 is a view illustrating a plurality of elbow connectors according to an embodiment of the invention plugged to a corresponding plurality of mating connectors arranged on a panel.

Referring to the figures, an embodiment of an electrical elbow connector 2 for interconnecting a multi-conductor electrical cable (not shown) to a mating connector 1 is shown. The mating connector 1 is intended to be mounted to a structure such as a panel or surface of a device to which the cable should be pluggably interconnected. The device may comprise a plurality of mating connectors arranged closely together for pluggably interconnecting the device to a plurality of cables.

The elbow connector configured for interconnecting the electrical cable to the mating panel connector, may further comprise other connection elements such as a fiber optic cable or a pneumatic or hydraulic connection.

The cable is a multi-conductor cable, and the elbow connector 2 comprises a plurality of electrical terminals 26 for connection to the conducting wires of the cable 3, and for plugging connection to a plurality of complementary terminals 26′ of the mating connector 1.

According to an embodiment of the invention, the elbow connector 2 comprises a casing 4, a connection terminal assembly 12 mounted within the casing 4, a cable clamping mechanism 10 to secure the cable to the casing, and a keying arrangement 8 comprising a least a polarizing element configured to orient the elbow connector in specific angular orientation relative to the complementary mating connector when the connector are plugged together, such that the electrical terminals of the elbow connector align in a single specific orientation with complementary mating electrical terminals of the mating connector. In addition to correct orientation of the connectors being plugged together, the keying arrangement may further comprise keying elements that allow an elbow connector with a certain keying arrangement to be plugged to a mating connector with a corresponding complementary keying arrangement 8′, and to prevent other elbow connectors with different keying arrangements from coupling to the mating connector. Such polarizing and keying arrangements 8, 8′ are per se known in the art and need not be described further herein. The keying arrangement thus orients the connection terminal assembly 12 and a corresponding plug portion 14 of the casing with respect to the mating connector and thus with respect to a device in which the mating connector is assembled.

The casing 4 comprises a plug portion 14, an elbow portion 16, and a fastener 18 fixing the plug portion 14 to the elbow portion 16 when the elbow connector is fully assembled. In an embodiment, the plug portion 14 of the casing may be a generally cylindrical tubular part.

The plug portion 14 comprises a latching mechanism 32 engageable with a complementary latching mechanism 32′ of the mating connector when the two are plugged together, in order to securely latch the elbow connector to the mating connector. In the illustrated embodiment, the latching mechanism 32 comprises one or more spring arms 34 each provided with a latching protuberance 36, such latching mechanisms being per se known in the art.

The elbow connector further comprises an unlocking member 6 for releasing the latching mechanism 32 to allow unplugging of the elbow connector from the mating connector. The unlocking member 6 in the illustrated embodiment comprises a slideable tubular sleeve 20 mounted around the plug portion 14 of the casing 4 and provided with an orifice 50 for receiving the latching protuberance therethrough, and an outer grip portion 52 that allows an operator to slide back the tubular sleeve such that the edge of the orifice 50 slides over a chamfered surface of the latching protuberance 36 to depress the spring arms 34 radially inwardly and release the elbow connector from the mating connector. Such a latching and unlocking mechanism is per se known in the art.

In the illustrated embodiment, the keying arrangement 8 is provided in a form of a protuberance projecting radially outwardly on the tubular sleeve 20 configured to slide into a complementary groove 8′ in the mating connector 1. The keying arrangement may however alternatively be provided on the plug portion 14 of the casing 4 or even within the connection terminal assembly 12. Instead of a protuberance on the elbow connector, the keying arrangement may also comprise a groove or slot on the elbow connector engaging a complementary protuberance on the mating connector.

The connection terminal assembly 12 comprises a plurality of electrical terminals 26 assembled in a terminal housing 28 comprising a dielectric insert 72 with terminal receiving cavities 74 within which the electrical terminals 26 are securely mounted.

The terminal housing 28 may further comprise a split outer shell 70 that mounts around the dielectric insert 72 and serves to secure and position the insert with respect to the plug portion 14 of the casing. The split outer shell serves to position and secure the dielectric insert and terminals to the plug portion 14 of the casing 4. In other embodiments (not shown), the outer shell 70 may be omitted and the functions thereof integrated into the dielectric insert 72 by adapting the outer surface of the dielectric insert as needed. The dielectric insert may for instance being in a form of plastic part (e.g. an injection molded part), or a part made of another insulating material, such as a ceramic material. Other known materials and bodies used for holding electrical terminals in a specific arrangement together may be provided within the scope of the invention. The terminal housing 28 is configured to be fixed immovably in a specific angular orientation and also in a specific axial position within the plug portion 14 of the casing 4. Interengaging elements on the dielectric insert, the split outer shell, and the plug portion may be provided to perform the positioning and locking function.

Each terminal 26 comprises a plugging portion 66 positioned within the plug portion 14 of the casing 4 for separable plugging connection with a complementary mating terminal 26′ of the mating connector, and a cable connection portion 68 configured for connecting to an electrical wire of the cable. The cable connection portion 68 may comprise a per se known arrangement, for instance a crimp connection, or insulation displacement connection, and/or solder connection. The plugging portion 66 may for instance be in a form of a pin contact that is inserted in a receptacle type of contact in the mating connector, or in the form of a receptacle type of contact for receiving a pin contact of the mating connector, or a combination of both pin and receptacle contacts on both the mating connector and elbow connector. Other types of mating electrical terminals, per se known in the art, may be provided without departing from the scope of the invention. Furthermore, the connector may not be exclusively electrical, and may also encompass hybrid connectors further comprising non electrical connection elements such as fibre optic terminals or hydraulic/pneumatic connections.

The cable clamping mechanism 10 comprises a collet 22 and a collet nut 24 provided with a thread 40 that engages a complementary thread 40 on the cable exit end of the elbow portion 16 such that the collet nut 24 can be tightened to the elbow portion of the casing. The collet 22 comprises a portion that inserts into the cable receiving end of the elbow portion and abuts an annular shoulder within the cavity of the elbow portion. The collet comprises clamp arms 56 provided with an outer chamfer 60a at a free and thereof that allows the clamp arms to be radially inwardly biased by an inner chamfer 60b of the collet nut when the collet nut is tightened to the elbow portion. The clamp arms 56 may optionally be provided with clamping teeth on an inner side thereof that dig into the outer sheath of the cable inserted therethrough. Such cable clamping mechanisms are per se known.

In order to prevent rotation of the collet within the cable receiving cavity end of the elbow portion 16, the collet is provided with an anti-rotation window 64 that receives therein an anti-rotation lug 42 extending integrally from the elbow portion 16. The anti-rotation lug 42 may advantageously be in a form of a tab partially cut out of the wall of the elbow portion. The anti-rotation lug is provided in an unbent or flush arrangement during insertion of the collet within the cable receiving cavity end of the elbow portion, and subsequently bent inwardly by a stamping or pressing process so to engage in the anti-rotation window 64. The latter arrangement provides a particularly cost effective and reliable manner of manufacturing and securing the collet 22 to the casing 4.

The plug portion 14 is assembled and securely held to the separate and separable elbow portion 16 by means of a fastener 18. As shown in the illustrated embodiment, the fastener may be in the form of a nut with a thread 38 on one end and a shoulder 48 on the other end, coupling to a complementary thread and a complementary shoulder respectively on the elbow and plug portions. In the illustrated embodiment, the thread 38 of the fastener 18 engages a thread on the elbow portion and the shoulder 48 engages a shoulder on the plug portion 14 of the casing to tighten and secure the plug portion to the elbow portion. Within the scope of the invention, other securing means such as a clamp mechanism may be employed to tighten the elbow portion to the plug portion.

The plug portion 14 and separate elbow portion 16 abut together in the assembled position at an interface 19. The interface 19a of the plug portion 14 comprises an orientation element 44a and the interface 19b of the elbow portion 16 comprises a complementary orientation element 44b. One of the interfaces may comprise a single orientation element or a plurality of orientation elements, whereas the other interface comprises a plurality of orientation elements if the other interface comprises only a single orientation elements such that the elbow portion may be oriented at different angles α around the plugging axis A with respect to the plug portion 14. For instance, in the illustrated embodiment, the orientation elements are provided in a form of protuberances or teeth on one of the interfaces engaging in complementary grooves of the other interface. The arrangement of the teeth on the interfaces may be identical or may differ, the arrangement allowing the elbow portion 16 to be positioned in a plurality of different discrete angular orientations with respect to the plug portion 14 such to change the direction of exit of the cable during assembly of the elbow connector, as best seen in FIG. 4. Once assembled, the elbow portion and plug portion of the casing cannot be rotated with respect to each other after the fastener 18 has been tightened thereby locking the orientation elements 44a, 44b into a locked and fixed position. Embodiments of the invention may include discrete angular increments of:
120° which provides three different positions around the full 360°;
90° which provides four different positions around the full 360°;
60° which provides six different positions around the full 360°;
45° which provides 8 different positions around the full 360°;
30° which provides 12 different positions around the full 360°;
22.5° which provides 16 different positions around the full 360°.

Preferred embodiments have either 45° or 30° angular increments since these provide a reasonable number of angular positions over the full 360° (8, respectively 12 discrete angular positions) which allow to easily adapt to obstacles proximate the connector, yet avoid having too many angular positions that are not easy to discern. Also, having a too large number of angular increments by further reducing the smallest discrete angle between angular positions may reduce the strength of the protuberances 44a, 44b and thus weaken the interface 19 between the elbow portion 16 and plug portion 14.

As best illustrated in FIG. 5, a plurality of mating connectors may be arranged on a panel or structure of a device 5 for plugging connection to a plurality of elbow connectors 2 whereby the mating connectors are for instance oriented with the same angular orientation requiring the connection terminal assembly 12 of the elbow connector to be plug thereto into the certain orientation. The cable exit however can be adjusted during assembly to the desired describe angular position as mentioned above. Thus, the exit direction of the cable 3 may be optimized as a function of the lay out and orientation of the mating connectors in a structure as illustrated in the example of FIG. 5.

List of references used

```
Elbow connector 2
      casing 4
            plug portion 14
                  fastening shoulder (elbow side) 30
                  latching mechanism 32
                        spring arm(s) 34
                        latching protuberance 36
                  orientation element 44a
            elbow portion 16
                  cable receiving cavity 17
                  fastening thread (for plug portion) 38
                  fastening thread (for collet nut) 40
                  anti-rotation lug 42
                  orientation element 44b
            fastener 18
                  nut
                        fastening thread 38
                        shoulder 48
      unlocking member 6
            tubular sleeve 20
                  orifice 50 for latching protuberance
                  outer grip portion 52
      keying arrangement 8
            key element(s) e.g. protuberance, groove, slot
                  provided on coupling ring
      cable clamping mechanism 10
            collet 22
                  clamp arms 56
                        free end
                              outer chamfer 60a
                              inner clamp teeth
                  anti-rotation window 64
            collet nut 24
                  thread 40
                  cam portion 60b
      connection terminal assembly 12
            terminals 26
                  plugging portion 66
                        pin contact
                  cable connection portion 68
                        crimp, IDC, solder
            terminal housing 28
                  split outer shell 70
                  (dielectric) insert 72
                        terminal receiving cavities 74
mating connector 1
      complementary keying arrangement 8′
            key element(s) e.g. protuberance, groove, slot
      complementary connection terminal assembly
            terminals (complementary) 26′
                  e.g receptacle terminals
      complementary locking mechanism 32′
cable 3
device 5
smallest discrete angle α of rotation of elbow portion
plugging direction A
```

1-14. (canceled)

15. Elbow connector for pluggable interconnection of an electrical cable to a mating connector, the elbow connector including a casing comprising a plug portion and a separate elbow portion, a connection terminal assembly mounted in the casing comprising a plurality of electrical terminals supported by a terminal housing mounted fixedly in the plug portion, and a keying arrangement complementary to a keying arrangement of said mating connector for angular orientation of the connection terminal assembly about a plugging axis relative to the mating connector, the elbow portion comprising a cable receiving cavity extending from a cable receiving end of the elbow portion to the plug portion through a bend, wherein the plug portion and elbow portion each comprise inter-engaging orientation elements configured to allow the elbow portion to be positioned at different discrete angular orientations about the plugging axis relative to the plug portion, the casing further comprising a fastener, configured for locking the plug portion to the elbow portion such that the chosen angular orientation of the elbow portion relative to the plug portion is locked.

16. Connector according to claim 15, wherein the cable receiving cavity in the elbow portion bends through 90°.

17. Connector according to claim 15, wherein the orientation elements comprise at least one protuberance or recess on one of the plug portion and elbow portion and a plurality of complementary recesses or protuberances on the other of the plug portion and elbow portion.

18. Connector according to claim 15, wherein the orientation elements are arranged such that the angular orientation of the elbow portion relative to the plug portion consists of discrete angular positions separated by at most 120°, preferably at most 90° and at least 5°

19. Connector according to claim 15, wherein the orientation elements are arranged such that the angular orientation of the elbow portion relative to the plug portion consists of discrete angular positions separated by at most 60° and at least 15°.

20. Connector according to claim 15, wherein the orientation elements are arranged such that the angular orientation of the elbow portion relative to the plug portion consists of discrete angular positions separated by 45° or 30°.

21. Connector according to claim 15, wherein the plug portion comprises a latching mechanism configured for latching the plug portion to the mating connector, the latching mechanism comprising at least one spring arm with at least one latching protuberance, the connector further comprising an unlocking member in the form of a tubular sleeve mounted around the plug portion and movable from a locking position to an unlocking position configured to actuate the spring arm to release the latching protuberance to enable unplugging of the elbow connector from the mating connector.

22. Connector according to claim 15, wherein the keying arrangement comprises a protuberance or groove in the plug portion, or in an unlocking member mounted around plug portion, engaging with a complementary groove or protuberance on the mating connector.

23. Connector according to claim 15, further comprising a cable clamping mechanism comprising a collet inserted in the cable receiving cavity of the elbow portion, and a collet nut engaging clamp arms of the collet to tighten the clamp arms around an outer sheath of the cable to secure the cable to the connector.

24. Connector according to claim 23, wherein the collet comprises an anti-rotation window and the elbow portion comprises an anti-rotation lug deformed into anti-rotation window when the collet is assembled in the elbow portion, the anti-rotation lug being in an undeformed state allowing insertion of the collet in the cable receiving cavity prior to assembly.

25. Connector according to claim 24, wherein the anti-rotation lug is in a form of a tab integrally formed and partially cut out of a side wall of the elbow portion.

26. Connector according to claim 15, wherein the orientation elements comprise teeth and complimentary recesses extending in the direction of the plugging axis from respective interfaces of the plug portion and elbow portion.

27. Connector according to claim 15, wherein the fastener is in the form of a nut comprising a thread engageable with a complementary thread provided on the elbow portion and a shoulder engaging a complementary shoulder on the plug portion of the casing.

28. Connector according to claim 15, wherein the plug portion comprises an essentially cylindrical or tubular shape.
